(19) United States
(12) Patent Application Publication
(10) Pub. No.: US 2005/0053543 A1
(43) Pub. Date: Mar. 10, 2005

(54) Method for preparing alkali metal ferrates and novel alkali metal ferrate granules

(76) Inventors: Alain Kneip, Saint Martin De Seignanx (FR); Jean Carol, Anglet (FR); Alain Castetbon, Sauveterre de Bearn (FR)

Correspondence Address: YOUNG & THOMPSON, 745 SOUTH 23RD STREET, 2ND FLOOR, ARLINGTON, VA, 22202, US

(21) Appl. No.: 10/495,788

(22) PCT Filed: Nov. 8, 2002
(86) PCT No.: PCT/FR02/03835

(30) Foreign Application Priority Data
Nov. 16, 2001 (FR) 01/14845

(51) Int. Cl. C01G 49/02

(52) U.S. Cl. 423/594.2

(57) ABSTRACT

The invention concerns a method for preparing an alkali metal ferrate, which comprises the following steps: (i) preparing a reaction mixture comprising at least an iron salt, at least an alkali or alkaline-earth metal hypochlorite and an alkali metal hydroxide; (ii) heating the mixture prepared at step (i) to a temperature ranging between 45 and 75° C., so as to form the alkali metal ferrate; (iii) recuperating the alkali metal ferrate formed at step (ii). The invention also concerns novel alkali metal ferrates.

The present invention relates to a process for the preparation of alkali metal ferrates, new granules of alkali metal ferrate as well as their uses, in particular for water treatment.

The ferrate ion, FeO₄ ⁻², in which the iron has a degree of valency of 6, is known be a powerful oxidizing agent.

The alkali ferrates, essentially FeO₄Na₂ and FeO₄K₂, are of use in certain organic or mineral chemistry processes and, quite particularly, in the treatment of waste water.

However, although known since the 19th century, ferrates also remain little used in this last application, in particular in Europe.

In fact, the use of chlorine alone or, sometimes, in combination with ozone is still preferred.

But if chlorine is a good oxidizing agent and a good bactericide, it is toxic and it can only be used in limited doses, which reduces its effectiveness.

Moreover, the action of chlorine on the hydrocarbons contained in water to be treated, can result in highly toxic and carcinogenic products. Finally, chlorine has the well-known drawback of conferring a disagreeable taste to the water.

The alkaline ferrates, in particular potassium ferrate, have the advantage of not being toxic, in contrast to chlorine, which explains the increasing interest that they elicit. Moreover, they are bactericides at low concentrations, of the order 10⁻⁵ and 10⁻³ mol/l, and they oxidize hydrocarbons without forming harmful products.

The ferrates can also form, after reduction, a colloidal precipitate of ferric hydroxide which can entrain with it solid bodies in suspension, undesirable heavy metals or anions such as phosphates, present in the water to be treated. This property allows the use of flocculants and basifying agents, such as sodium alginate or aluminium sulphate to be avoided.

Numerous processes for the preparation of alkaline ferrates have been proposed. Thus, the French Patent Application No. 2635318, describes a process for the preparation of an alkali metal or alkaline-earth metal ferrate from a mixture of a iron salt (II) or (III) and an alkali metal or alkaline-earth metal hypochlorite, forming a first layer, on which a second layer formed of alkali metal or alkaline-earth metal hydroxide granules is deposited. The mixture of these layers, arranged in a receptacle subjected to vibration, is taken to a temperature which is necessarily maintained below 40° C.

After elimination of the residues in the form of powder by sieving and elimination of the excess hydroxide by washing with an organic solvent, the granules comprising the ferrate are recovered. These granules are dehydrated by oven drying at a temperature comprised between 105 and 140° C. for eight to eighteen hours.

This process has the advantage of being simpler and shorter than the processes for the preparation of ferrates known then. However, the ferrate granules obtained by this process have some drawbacks.

Thus, these granules are not very stable over time and their ferrate content reduces over time, so that they rapidly become unusable. Moreover, these granules are friable so that, when they are packaged and stored, they easily crumble and form powders which is inconvenient for the user.

These drawbacks are also found in the alkali metal ferrates prepared according to other known processes; which explains why, despite their great potential usefulness in the treatment of water, in particular with respect to chlorine, alkali metal ferrates remain little used.

A first subject of the present invention is a process for the preparation of more stable alkali metal ferrates, obviating the drawbacks mentioned above.

A subject of the invention is also granules comprising alkali metal ferrates, which are stable over time and have a hardness never attained with the ferrate granules of the prior art.

Thus, the invention relates to a process for the preparation of an alkaline metal ferrate characterized in that is carried out in the following steps:
(i) a reaction mixture is prepared comprising at least one iron salt, at least one alkali or alkaline-earth metal hypochlorite and an alkali metal hydroxide,
(ii) the reaction mixture prepared in step (i) is heated to a temperature comprised between 45 and 75° C., so as to form the alkali metal ferrate,
(iii) the alkali metal ferrate formed in step (ii) is recovered.

Without wishing to be bound by theory, the inventors consider that the heating carried out in step (ii), allows the hygrometry in the reaction medium to be controlled. Now, the presence of water could be the source of the instability of the ferrates prepared according to the processes of the prior art, in particular the process described in the French Patent Application No. 2635318, mentioned above.

Moreover, this heating allows the long final dehydration step, which it is necessary to implement in this prior art process, to be avoided.

Other advantages resulting from the process of the present invention will become apparent from the description which follows.

Usually, the iron salt used in step (i) of the process of the invention is iron sulphate, in particular hydrated ferrous sulphate. Preferably, the ferrous sulphate is mono-, tetra- or heptahydrated.

According to a particularly advantageous aspect of the present invention, a basic iron sulphate is used as the iron salt, in particular a basic iron sulphate of formula (OH) Fe(SO₄) or (SO₄Fe)₂O.

The basic iron sulphate can be prepared, in a manner known to a person skilled in the art, from one of the ferrous sulphates mentioned above. But, preferably, it is prepared from monohydrated ferrous sulphate

In order to prepare the basic iron sulphate from monohydrated ferrous sulphate, the latter can be heated to a temperature greater than 170° C., preferably comprised between 180 and 220° C., and this temperature is maintained for approximately 8 to 20 hours. Then the desired basic iron sulphate is recovered.

The alkali metal or alkaline-earth metal hypochlorite can consist of sodium hypochlorite, potassium hypochlorite, barium hypochlorite or, preferably, calcium hypochlorite. In fact use of the latter allows the process of the invention to be implemented in solid phase.

The alkaline hydroxide can consist of sodium hydroxide or, preferably, potassium hydroxide.

The reaction mixture used in step (i) is generally prepared in the chamber of a reaction vessel such as a rotary reaction vessel.

Preferably, the alkali metal or alkaline-metal earth hypochlorite and the iron salt are introduced together, into the chamber of the reaction vessel, then the alkali metal hydroxide.

The above compounds, which are constituents of the reaction mixture of the invention, are all generally in solid form.

The alkali metal or alkaline-earth metal hypochlorite and the iron salt can be in the form of an intimate premixture before their introduction into the chamber of the reaction vessel. With a view to producing such a premixture, said hypochlorite can be in the form of a powder the average diameter of the particles of which is comprised between 10 and 100 μm and the iron salt in the form of a powder the average diameter of the particles of which is comprised between 0.1 mm and 1,5 mm.

The alkali metal or alkaline-earth metal hypochlorite can be in the form of pellets with a diameter comprised between 2 and 6 mm.

The constituent compounds of the reaction mixture can be in a pure form. But, most often, in particular on an industrial scale, commercial compounds are used which include impurities.

Thus, the commercial alkali metal or alkaline-earth metal hypochlorite compound which is used within the scope of the present invention can consist of a product the alkali metal or alkaline-earth metal hypochlorite titre of which is greater than 70% by weight.

The commercial alkali metal hydroxide which is used within the scope of the present invention can consist of a product the alkali metal hydroxide titre of which is greater than 80%, preferably greater than 85% by weight.

Advantageously, in the reaction mixture, the mass constituted by the iron salt and the alkali metal or alkaline-earth metal hypochlorite, is at least two times, preferably three to four times greater than the mass of alkali metal hydroxide, that these compounds have in the pure form or consist of commercial products as mentioned above. The weight ratio between the iron salt and the alkali metal or alkaline-earth metal hypochlorite in such a reaction mixture can be comprised between 40/60 and 60/40, preferably between 45/55 and 55/45.

The fact of using a reaction mixture where, together, the iron salt and the hypochlorite have a more significant mass than that of the hydroxide, allows a ballast of iron salt and hypochlorite to be constituted. This ballast confers on the reaction mixture a good homogeneity, a regular distribution of its constituents and the means to absorb impacts between the ferrate granules during formation.

During step (ii), the reaction mixture can be advantageously taken to a temperature comprised between 60 and 75° C., more preferentially between 60 and 65° C.

Generally, the reaction mixture is heated to a such temperature for 1 to 5 hours, preferably 2 to 4 hours.

According to a particularly advantageous aspect of the invention, heating of the reaction mixture is carried out using infrared radiation, preferably short or medium infrared rays, in particular infrared rays with a wavelength comprised between 0.8 and 2 nanometres.

According to another aspect of the invention, heating the reaction mixture is carried out with ambient air, which contains carbon dioxide. Usually, the ambient air comprises between 0.005 and 0.1%, preferably between 0.01 and 0.05% by volume, of carbon dioxide.

Generally, the alkali metal ferrates of the reaction medium are recovered, by separating them, for example, by sieving, the excess iron salt and alkali metal hypochlorite being able to be used. This excess can be reused for preparing new ferrates in accordance with the process of the present invention.

Usually, the alkali metal ferrates recovered are in the form of granules.

The alkali metal ferrates which can be prepared using the process described above, constitute another subject of the invention.

According to another aspect of the invention, this consists of granules constituted:
by a core comprising an alkali metal ferrate and
by a surface protective coating comprising at least one alkali metal carbonate.

This protective coating is usually present on at least 90%, preferably 95% and more preferentially, 100% of the surface of the granule.

It is notable that this coating does not contain iron or a compound containing iron, at detectable levels using conventional measurement methods, such as ESCA (Electron Spectroscopy for Chemical Analysis). This method consists of photoelectron spectroscopy according to which an energy analysis of the electrons ejected by a substance irradiated with X-rays is carried out (in the case of a solid).

The alkali metal ferrate content of a granule of the invention can be comprised between 5 and 30% by weight, preferably between 15 and 25% by weight.

The coating can more particularly comprise 30 to 45% of carbon, 20 to 35% of at least one alkali metal and 25 to 40% of oxygen (atomic %). These granules can have a diameter comprised between 4 and 9 mm, preferably between 5 and 6 mm.

They are usually of spherical form, but can be in another form. In such a case, the term “diameter” corresponds to the largest distance between two points situated at the surface of the granule of the invention.

The protective coating can have an average thickness comprised between 10 and 50 μm.

The granules according to the invention can be prepared using the process described above, carried out in ambient air, which contains carbon dioxide. Usually, the ambient air comprises between 0.005 and 0.1%, preferably between 0.01 and 0.05% by volume, of carbon dioxide.

These granules are particularly stable, their alkali metal ferrate titre being able to remain substantially constant over a period of at least 6 months. By the expression “substantially constant”, is meant that this ferrate titre varies by no more than 2% by weight over a given period, of at least 6 months.

At least 90% of the iron present in the granules of the invention is in the form of ferrates, which is quite exceptional in comparison with the granules of ferrates obtained by the known processes.

Moreover, said granules are particularly hard to break. The alkali metal ferrates which are able to be prepared by the process described above and the granules according to the invention, can be used as oxidizing agents, in particular for the treatment of water, in particular waste water. As regards the treatment of water, the products of the invention can be used at concentrations comprised between 10⁻⁵ and 10⁻3 mol/l.

The following example illustrates the invention.

### EXAMPLE

### Process for the Preparation of Granules of Potassium Ferrates

The chamber of a rotary reaction vessel is taken to a constant regulated temperature of 65° C., using infrared radiation, then the following are introduced into it (in % with respect to the final mixture):
a premixture of 38% by weight of hypochlorite calcium in powder form titrating at least 70% and 40% by weight of basic iron sulphate; and, immediately after,
22% by weight of potassium hydroxide in pellets, titrating at least 84%.

The calcium hypochlorite of the premixture is in the form of a fine powder comprising particles with a size comprised between 10 and 100 μm. The basic iron sulphate of the premixture comprises particles with a size comprised between 0.1 and 1.5 mm.

The mixture thus produced is heated for two hours at 65° C., until the complete conversion of the potassium hydroxide.

The granules composed of a core of potassium ferrates and a surface protective coating are then separated by sieving.

Due to their hardness, it was not necessary to take particular precautions to carry out sieving.

The surplus basic iron sulphate and calcium hypochlorite were recovered with a view to a new preparation of potassium ferrate granules.

The elemental composition of the coating of the granules obtained can be determined.

The results (in atomic %) obtained are shown in Table I which follows:

TABLE 1

| Element | Coating |
|---|---|
| Carbon | 39 |
| Oxygen | 30 |
| Potassium | 27 |
| Iron | DL⁽¹⁾ |
| Chlorine | 1 |
| Sodium | 3 |
| Sulphur | DL⁽¹⁾ |
| Calcium | DL⁽¹⁾ |

DL⁽¹⁾ is the detection limit of the measurement device.

The protective coating of the granules is essentially constituted by carbonates devoid of iron; the iron being totally contained in the core.

90% of the total iron is in the form of ferrate.

These granules are shown to be stable over a period of one year.

1. Process for the preparation of an alkali metal ferrate, characterized in that it is carried out in the following steps:
(i) a reaction mixture is prepared comprising at least one iron salt, at least one alkali or alkaline-earth metal hypochlorite and an alkali metal hydroxide,
(ii) the reaction mixture prepared in step (i) is heated to a temperature comprised between 45 and 75° C., so as to form the alkali metal ferrate,
(iii) the alkali metal ferrate formed in step (ii) is recovered.

2. Process according to claim 1, characterized in that the iron salt is a basic iron sulphate.

3. Process according to claim 1, characterized in that said hypochlorite is calcium hypochlorite.

4. Process according to claim 1, characterized in that the alkali metal hydroxide is sodium hydroxide or, preferably potassium hydroxide.

5. Process according to claim 1, characterized in that the hypochlorite is in the form of a powder the average diameter of the particles of which is comprised between 50 and 100 μm and the iron salt is in the form of a powder the average diameter of the particles of which is comprised between 0.1 mm and 1.5 mm.

6. Process according to claim 1, characterized in that the mass constituted by said iron salt and said hypochlorite is at least two times, preferably three to four times greater than the mass of alkali metal hydroxide.

7. Process according to claim 1, characterized in that the temperature to which the mixture is heated is comprised between 60 and 75° C.

8. Process according to claim 1, characterized in that said mixture is heated using infrared.

9. Process according to claim 1, characterized in that the reaction mixture is heated in ambient air.

10. An alkali metal ferrate, characterized in that it is able to be prepared by the process according to claim 1.

11. Granules constituted:
by a core comprising an alkali metal ferrate and
by a surface protective coating comprising at least one alkali metal carbonate.

12. Granules according to claim 11, characterized in that said coating comprises 30 to 45% of carbon, 20 to 35% of at least one alkali metal and 25 to 40% of oxygen (atomic %).

13. Granules according to claim 11, characterized in that said protective coating is substantially devoid of iron or of compound comprising iron.

14. Granules according to claim 11 characterized in that they have a diameter comprised between 4 and 9 mm.

15. Granules according to claim 11 characterized in that the protective coating has an average thickness comprised between 10 and 50 μm.

16. Use of an alkali metal ferrate according to claim 10, as an oxidizing agent.

17. Use of an alkali metal ferrate according to claim 10, as an agent for the treatment of water.
